(19) United States
(12) Patent Application Publication
(10) Pub. No.: US 2002/0146125 A1
(43) Pub. Date: Oct. 10, 2002

(54) CA system for broadcast DTV using multiple keys for different service providers and service areas

(76) Inventors: Ahmet Eskicioglu, Indianapolis, IN (US); David Jay Duffield, Indianapolis, IN (US); Billy Wesley Beyers, Carmel, IN (US); Michael Scott Deiss, Zionsville, IN (US); David Emery Virag, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 09/962,970

(22) Filed: Sep. 25, 2001

Related U.S. Application Data
(63) Continuation-in-part of application No. 09/743,653, filed on Mar. 14, 2001.

(51) Int. Cl. H04K 1/00

(52) U.S. Cl. 380/255; 380/200

(57) ABSTRACT

A method for managing access to scrambled broadcast or transmitted events received from a variety of service providers (including broadcast television networks, cable television networks, digital satellite systems). In one preferred embodiment, each service provider employs a different public key for encrypting the access information message, and each smart card includes the corresponding private keys for the public keys, thereby permitting a user to access events from various service providers without changing the smart card.

This is a Continuation-in-Part of co-pending U.S. application Ser. No. 09/743,653 filed Jan. 12, 2001, which are hereby incorporated herein by reference.

### FIELD OF THE INVENTION

The present invention concerns a system and method that may be employed to provide conditional access to multiple broadcast services by a single consumer electronic device, such as a set-top box or a digital television. Each device is capable of receiving broadcast or transmitted digital streams from a variety of broadcast sources.

### BACKGROUND OF THE INVENTION

In the near future, broadcast digital television services may comprise several local channels, each of which may broadcast multiple simultaneous programs, some of these programs being pay-per-view programs. A user may want a mix of services from several of the different service providers, thereby necessitating the use of a conditional access system, or similar scheme. For example, a user may want to purchase all of the Indiana University basketball games from local channel 4 and purchase all of the Notre Dame football games from channel 13 and purchase all of the Indianapolis Colts games from channel 8. If each of these services were uniquely scrambled, the user would be burdened with purchasing multiple conditional access smart cards and swapping the cards as the user channel surfs.

As noted above, conventional systems include cable, satellite, and terrestrial broadcast systems. Each of these systems may have multiple descrambling keys associated therewith. Some of these systems may even have multiple descrambling keys for each different Entitlement Control Message (ECM). ECMs carry descrambling keys (sometimes referred to as ‘control words’) and a brief description of the program (e.g., program number, date, time, cost, etc.). For example, in a cable system, some content may be scrambled on a national basis, and other content may be scrambled on a local basis, each with different ECMs and description of the program (e.g., program number, date, time, cost, etc.). For example, in a cable system, some content may be scrambled on a national basis, and other content may be scrambled on a local basis, each with different ECMs and descrambling keys. However, one thing that all the above-referenced systems have in common is that they all are designed to receive programming from one and only one known transmitter (e.g., the head end of the cable plant (cable), a particular orbital position for a satellite (satellite), or a single television station (terrestrial broadcast)). Because all the programming for these systems comes from one transmitter, the system knows a priori which set of descrambling keys to use at any one time.

Thus, there is presently a need for a conditional access system which uses multiple keys associated with different broadcasters or different geographic regions.

### SUMMARY OF THE INVENTION

Generally, the present invention defines a method for providing conditional access to a restricted broadcast or transmitted event. The method comprises the steps of: receiving at least one first transmitted event from a first service provider, said transmitted event being scrambled, receiving at least one second transmitted event from a second service provider, said transmitted event being scrambled, receiving encrypted access information associated with said transmitted events, said access information including first and second descrambling keys, said first descrambling key corresponding to said first service provider and said second descrambling key corresponding to said second service provider, decrypting said access information; and, descrambling said transmitted events.

### BRIEF DESCRIPTION OF THE DRAWINGS

FIG. 1 is a block diagram illustrating one architecture for interfacing a common digital television to a plurality of terrestrial broadcasters; and

FIG. 2 is a block diagram of an exemplary implementation of a system for managing access to a device in accordance with the invention.

### DETAILED DESCRIPTION OF THE PREFERRED EMBODIMENTS

The present invention provides a conditional access system, which may be utilized to obtain services from one of a plurality of sources. The conditional access system when implemented within a digital television (DTV), digital videocassette recorder (DVCR), set-top box (STB) or the like, permits a user to receive scrambled events from more than one service provider without swapping conditional access modules or smart cards. Alternately, the functionality of the smart card may be embedded within the DTV. Such a conditional access system may act as a toll bridge for access to services thereby permitting a mechanism for the manufacturer of the DTV to collect fees based on use of its DTV. Similarly, this invention may be implemented within a set-top box (STB) or digital videocassette recorder (DVCR); for simplicity, the below description of the invention will be directed towards an implementation using a digital television and a smart card coupled thereto.

A ‘balkanization’ of descrambling key areas is suggested as a method for combating piracy in a conditional access system, such as the one described above. This method involves using different keys, each covering only a small geographic area. Thus, if a pirate managed to acquire one descrambling key, the area in which that key would be useful would be very limited.

An event or program as described herein comprises one of the following: (1) audio/visual data such as a movie, weekly “television” show or a documentary; (2) textual data such as an electronic magazine, paper, or weather news; (3) computer software; (4) binary data such as images or (5) HTML data (e.g., web pages). The service providers include any provider broadcasting events, for example, traditional broadcast television networks, cable networks, digital satellite networks, providers of electronic list of events, such as electronic program guide providers, and in certain cases internet service providers.

Such a conditional access system as the one described above may be based on public key technology. At least one public key (number) is available to all service providers. This may be the public key for every smart card in the conditional service system, or multiple public keys may be used. Each smart card has stored therein at least one secret private key that can decrypt messages encrypted by the at least one public key.

In operation, the conditional access service provider sends a CA entitlement message (e.g., ECM) in the transmission stream encrypted by the public key that contains information such as the name of the service provider, the name, time, and cost of the program, and information about the keys used to scramble the program. This message is decrypted by the smart card using the private key, and the appropriate information is stored in the smart card for each event purchased.

The smart card has a certain amount of credit for purchases that has been enabled by the bank. As long as the limit is not exceeded, programs can be purchased by the viewer. At some appropriate preprogrammed time, the smart card forces a telephone call to the CA center. Using another set of keys, the CA center in cooperation with a bank receives billing information from the smart card and provides additional credit. The bank forwards the information and credits the appropriate service provider or providers.

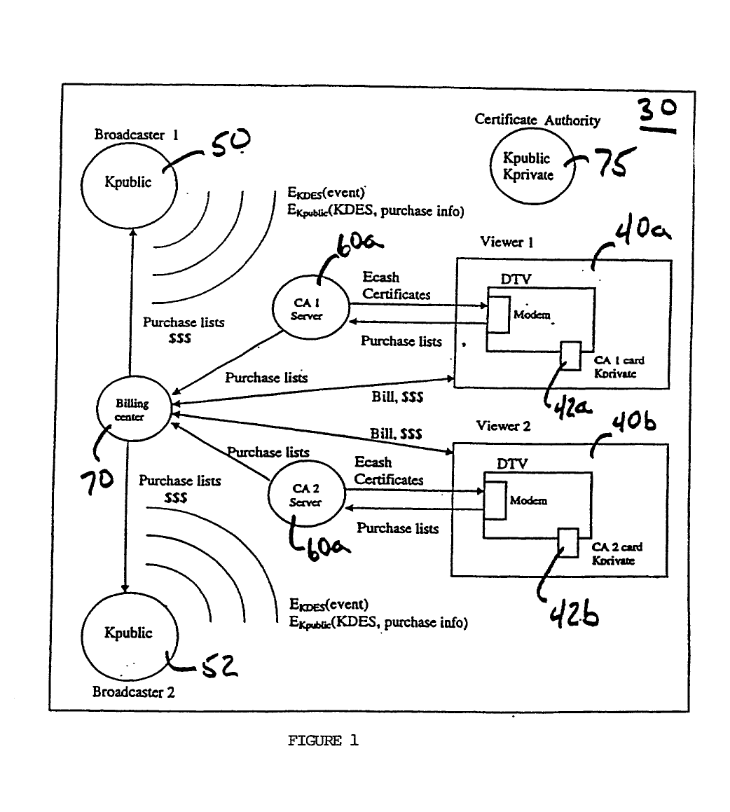

In FIG. 1, system 30 depicts the general architecture for managing access to a digital television (DTV) 40a, 40b. For simplicity the following description will be limited to a single DTV 40a. Similar element numbers define the same functional element. Smart Card (SC) 42a (or any other equivalent conditional access module) is inserted into or coupled to a smart card reader (not shown) of DTV 40a; bus 45 interconnects DTV 40a and SC 42a thereby permitting the transfer of data therebetween. Such smart cards include ISO 7816 cards having a card body with a plurality of terminals arranged on a surface in compliance with National Renewable Security Standard (NRSS) Part A or PCMCIA cards complying with NRSS Part B. Such smart cards also include ISO 7816 cards, PCMCIA cards, NRSS Part A and Part B cards, Open Cable Point of Deployment (POD) modules, Digital Video Broadcast (DVB) Common Interface (CI) modules and other proprietary designs known to those skilled in the art.

DTV 40a can receive services from a plurality of service providers (SPs), such as a broadcast television stations 50 and 52, a cable television operator (not shown), and a satellite system (not shown). This invention finds particular benefit in terrestrial broadcasting. Certificate authority (CA) 75 is not directly connected to either the service providers or DTV 40a but issues digital certificates and public and private key pairs, which are used as explained below. It is within the scope of this invention that the role of certificate authority 75 may be performed by the service providers in collaboration with the manufacturer of the DTV 40a. Billing center 70 is utilized to manage the user's accounts; updated information is provided as users make arrangements to purchase additional services and as these services are consumed or used.

Such a Conditional Access (CA) system designed for DTV broadcast technology is a transport-based system. This means that CA information for a particular broadcaster is transmitted only on its own RF channel. Each broadcaster is responsible for its own information and hence, there is no need for pre-established code of conducts to coordinate and/or synchronize information among several broadcasters. Further, the CA system is based on “E-cash” card loading. A user pre-loads his/her card with a certain amount of cash (from debit or credit accounts), and then uses the card to buy event packages, pay for monthly subscriptions, or buy specific programs in PPV mode. An event package may include, for example, all the games of your favorite professional sports franchise or all the late Sunday movies on one or more virtual channels.

The broadcast channel is used only to deliver the services and information for access to these services. All the remaining transactions are carried out using a return channel (i.e., a modem and a phone connection). Broadcasting of addressable messages is not needed. The broadcast services are protected using a common scrambling algorithm. The keys used in this process and event purchase information are encrypted with a global public key, and delivered to the user via the MPEG-2 stream. For event packages, package certificates are sent to the user, from the CA server 60a, via the return channel. As described below in more detail, certificates are usually signed to ensure integrity of the certificate. That is, to ensure that the proper and unmodified certificate is received from the sender. Services are accessed through a renewable security module (e.g., smart card).

Symmetric key cryptography involves the use of the same algorithm and key for both encryption and decryption. The foundation of public-key cryptography is the use of two related keys, one public and one private. The private key is a secret key, and it is computationally unfeasible to deduce the private key from the public key, which is publicly available. Anyone with a public key can encrypt a message but only the person or device having the associated and predetermined private key can decrypt it. Similarly, a message can be encrypted by a private key and anyone with access to the public key can decrypt that message. Encrypting messages using a private key may be referred to as “signing” because anyone holding the public key can verify that the message was sent by the party having the private key. This may be thought of as being analogous to verifying a signature on a document.

A digitally signed message is a message sent in the clear (i.e., unencrypted) having a signature attached thereto. The attached signature is produced by encrypting either the message itself or a digest of the message; a digest of the message is obtained by hashing the message. (Hashing involves subjecting the message to a one-way hashing algorithm, such as MD5 developed by Ron Rivest or SHA-1 developed by the National Institute of Standards and Technology (NIST) and the National Security Agency (NSA) prior to encrypting the message.) Thus, the recipient of the signed message can verify the integrity (i.e., the source or origin) of the message. (In comparison, a public key certificate or digital certificate is a message, containing a public key sent in the clear having a signature attached thereto.) Signature verification involves checking the signature by decryption.

As defined above, the five essential components of the CA system are the broadcaster, the CA vendor, the billing center (e.g., a bank), the end user, and the Certificate Authority. FIG. 1 illustrates the overall system architecture, and identifies these five components with their communication links and data flows. The end user communicates with the CA vendor for downloading certificates through a point-to-point link such as a telephone line. The telephone line is used for automatic transactions and for voice connection when necessary. For automatic transactions, one enabling protocol is the Point-to-Point Protocol (PPP). Security is implemented at the application layer using private protocols.

Communication between the CA vendor and the broadcaster may be established through a Local Area Network (LAN) or Wide Area Network (WAN). As before, security is embedded at the application level using privately-defined protocols running over existing internetworking protocols. The broadcast facility equipment needed to protect the broadcast streams can be an off-the-shelf product available from multiple CA vendors.

Broadcasters are responsible for delivering: (1) the services, and (2) the entitlement messages. Such entitlement messages include access information messages (AIMs) described below in more detail, (or alternatively entitlement control messages (ECMs) and entitlement management messages (EMMs)) that allow any user to buy those services. Communication between a broadcaster and the user therefore follows the point-to-multipoint model of broadcast technology. Broadcast AIMs do not contain addresses unique to each user or subscriber, which is typical with satellite or cable systems.

If DTV 40a does not have a back channel connection needed to communicate with the CA server then loading cash to the card requires the user to either access a DTV unit with back-channel support or go to a particular location (bank, ATM, vendor's regional office) to have the card loaded. The CA operators act like the card holder's or user's bank, while the billing center acts like the merchant's bank. The card association could be the middleman between the CA operators and the broadcasters'banks that provides a transaction settlement service. The fixed amount of “cash” loaded into the smart card or conditional access module can now be used to pay of services offered by a broadcaster.

Whichever cash transfer mechanism is employed, the user requests a transfer of a specific amount of money to the CA card from a credit or debit account. After proper verification of the subject's identity and validation of user resources, the transaction is authorized, and the nominal amount of money is stored in the CA card.

Once money is loaded into the card, a user can buy any number of services offered by broadcasters. Each purchase reduces the amount of available money in the card by the service price. The services offered by broadcasters can be classified into two categories; PPV events and packages. An event is a TV program with an allocated slot in a program guide and a package is simply a collection of events. Examples of packages are (1) all the NBA games in a given season, (2) the late Sunday movies on one or more virtual channels, (3) subscription to a particular virtual channel such as HBO.

All events may have one or more of their audiovisual streams scrambled using a common symmetric key algorithm. Entitlement messages (e.g., ECMs, AIMs), which contain purchase information and descrambling keys, may be encrypted with a common public-key algorithm or a symmetric key algorithm.

Upon purchase of an event, a record may be stored in the smart card which may be later transferred to the CA vendor. Once the stored purchase information is sent to the CA database, a CA vendor can pay broadcasters for the provided services. In addition, each smart card has non-volatile memory to keep the information described below.

A 32-bit field of the smart card memory represents the card serial number. A 128-bit BCD field for the user (credit or debit) card number. A 10-byte field for the CA server phone number. A 10-byte field for an alternate CA server phone number. A 40-bit BCD field to store the amount of money available to the user. A field for a signature on the last E-cash certificate. An 8-bit field to store a threshold value to inform the user that the available E-cash is less than a predetermined threshold or to initiate an automatic call back to the CA server to add money. A 40-bit BCD field for the amount of money downloaded to the card without user involvement when E-cash is less than the threshold. The amount is determined by the user and sent to the CA server during card activation. If this value is zero, automatic E-cash download will not be allowed. Two 768-bit fields for storing the private key for decrypting the AIMs and for storing the public key for verifying the signature on certificates. A 21-byte field for storing the TDES key for descrambling the broadcast services. Two 96-byte fields for storing the key to replace the current private key and for the key to replace the current verification key. An 8-byte field for storing the symmetric key for secure communication with the CA server is also provided. It is within the scope of this invention that a scrambling algorithm may be a cipher other than DES.

The card must store information for PPV events and the packages purchased by the user. If the card memory is full, the user will not be allowed to purchase additional events.

Data exchange between the card and the host (e.g., CA provider) may be based on a well-defined common interface, i.e., the National Renewable Security Standard (NRSS), EIA-679 Part A or Part B. Since the phone line is a widely available physical link, the chosen protocol between the CA server and the host is the Point-to-Point protocol (PPP), RFC 1548, adopted as Standard 51 with security provided within PPP datagrams. The technological innovation described herein does not preclude the use of alternative protocols different from PPP on the return channel.

PPP is a protocol based on the HDLC standards of ISO, as adopted by the ITU-T for X.25 systems. It was developed by IETF to transport datagrams from multiple protocols over point-to-point links. The frame format is a 16 bit protocol field (defined in RFC 1700, “Assigned Numbers”), followed by an information field of variable length and then followed by a padding field containing optional bytes added to adjust the frame length (if required by the receiving protocol).

For exchanging data between the card and the CA server, a new protocol is defined, having a protocol field value 0×00FF. The value of the padding field is always zero for this new protocol. The new protocol provides reliable transmission using acknowledgment (ACK) and negative acknowledgment (NACK) messages which are inserted into the first byte of the Information field both messages utilizing an 8-bit UIMSBF format.

An ACK may be followed by information (piggyback acknowledgment) sent as a reply. If the receiving end detects a corrupted message, it responds with a NACK, and requests retransmission by the sender.

Using the above protocol, the smart card initiates a callback to the CA server under any of the following conditions:

1. The card has been inserted into the DTV for the first time.

2. The user has entered a request for an advanced package purchase using a displayed menu.

3. The smart card memory is full.

4. The local time is within the interval [1 am-6 am] and there are new records to be sent.

5. The card has received a notification for a new private key or verification key.

6. The smart card money is less than the specified threshold and automatic E-cash download is enabled.

7. The user has entered a request for money using a displayed menu.

8. The user has entered a request to cancel a package purchase.

Depending on the condition, the card sends an initial alerting message to inform the CA server about the user and the purpose of the call.

When the user inserts the card into the DTV for the first time, the information specific to the card is sent to the CA server for registration. This information is encrypted with Kcallback.

Card→CA server: Alert message (with alert_type=0×01)

Card←CA server: ACK message

Card→CA server: Card information message

Card←CA server: ACK message

An advanced purchase can be made using a displayed menu. In response to the user request, the CA server sends a package certificate that will be saved on the card. For example:

Card→CA server: Alert message (with alert_type=0×02)

Card←CA server: ACK message|Signed package certificate message

Card→CA server: ACK message

The Package Certificate format contains the following fields. An 8-bit field that indicates a package certificate message. Two values are possible, one for renewable package subscription and one for non-renewable package subscription. A 32-bit field that identifies the registration authority that assigns values to the provider_index field. A 16-bit field that identifies the content provider. This unique number is registered with the registration authority identified by the format_identifier. A 16-bit field that identifies the transport stream where the event is being carried. A 16 bit field that indicates the package identifier. An 8-bit field for the title field. A variable length field for the title of the package using ASCII with Latin-1 extensions. A 40-bit field which indicates the price of the package in BCD format. A 24-bit field which indicates the expiration date of the package.

The PPV event purchase records are temporarily stored in the card until after the event is broadcast. They are sent to the CA server without user involvement and when either:

(i) the card memory is unable to store more records or

(ii) the local time is in the interval [e.g., 1 am-6 am] and there are new records to be sent.

All records are encrypted with Kcallback.

(i) Smart card memory is full

Card→CA server: Alert message (with alert_type=0×03)

Card←CA server: ACK message

Card→CA server: A variable number of encrypted PPV event purchase records

Card←CA server: ACK message

(ii) The local time is within the interval [1am-6am] and there are new records to be sent

Card→CA server: Alert message (with alert_type=0×04)

Card←CA server: ACK message

Card→CA server: A variable number of encrypted PPV event purchase records

Card←CA server: ACK message

When the private key or verification key needs to be replaced, a notification is sent to the cards using the broadcast channel. Each user is then required to initiate a callback to receive the new key.

Card→CA server: Alert message (with alert_type=0×05)

Card←CA server: ACK message|Key replacement message

Card→CA server: ACK message

Money is added to the card when:

1. the smart card money is less than a specified threshold or

2. the user enters a request for money using a displayed menu or

3. the card is taken to a remote location (if there is no local phone connection).

In all cases, the entity providing the money verifies the credit or debit card information, generates an E-cash Certificate (ECC), and sends it to the card. The ECC message format is an 8-bit field for the message type and 40-bit field to hold the BCD value of the amount of money to be added to the smart card.

1) Automatic E-cash download is enabled:

Card→CA server: Alert message (with alert_type=0×06)

Card←CA server: ACK message

Card→CA server: Signature on E-cash

Card←CA server: ACK|Signed E-cash certificate message

Card→CA server: ACK message

2) The E-cash Certificate contains the predefined, fixed amount of E-cash. Automatic E-cash download is disabled. The user proceeds as follows;

Card→CA server: Alert message (with alert_type=0×07)

Card←CA server: ACK message

Card→CA server: Signature on E-cash|E-cash amount message

Card←CA server: ACK message|Signed E-cash certificate message

Card→CA server: ACK message

The user can cancel a purchase by using a menu displayed on the screen. The action taken by the card depends on the type of the purchase:

(i) Package purchase: A call is initiated to the CA server.

Card→CA server: Alert message (with alert_type=0×08)

Card←CA server: ACK message

Card→CA server: Canceled package purchase record

Card←CA server: ACK message|Signed E-cash certificate message

Card→CA server: ACK message

(ii) PPV event purchase: If the deadline for canceling the event has not been reached, the chosen record is deleted entirely.

The AIMs are carried as private data in the adaptation field of the Transport Stream packets carrying video data. These AIMs could also be carried in the Transport Stream with different PIDs using the tools and functions available for ECM transmission in MPEG-2. The adaptation_field control bits shall be ‘10’ (Adaptation field only, no payload) or ‘11’ (adaptation field followed by payload). The maximum cycle time for AIM messages with the same AIM_id shall be 500 ms.

The bit-stream syntax for the Access Information Message contains the following fields. A unique 8-bit identifier of this access information message. The AIM_id field is the second byte in the private data section of the adaptation field. The first byte is allocated for identifying the public key used in protecting the AIM (if multiple public keys are used in a given DMA). An 8-bit field specifying the number of bytes in the AIM immediately following the AIM_length field. A 32-bit field that identifies the registration authority that assigns values to the provider_index field. A 16-bit field that identifies the content provider. This unique number is registered with the registration authority identified by the format_identifier. A 24-bit field that identifies a particular TV program or event. Assigned by the content provider identified by provider_index, it identifies uniquely all those programs registered in the content provider data base. A 16-bit field that identifies the Transport Stream where the event is being carried. A 16-bit field that identifies uniquely the particular service where the event is being transmitted. A 14-bit field that identifies uniquely a particular event within a given service of this Transport Stream. While program_event_id is a value that identifies an event for a content provider, event_id is the program guide index of an event. A broadcaster who acts simultaneously as a content provider may want to have both numbers equal, but this may not be valid otherwise. A 32-bit field indicating the event start time. A 20-bit field indicating the length of the event measured in seconds. A 10-byte field for storing the first 10 characters of the English title for the event that this message describes. If the actual title has less than 10 characters, then the title segment must be padded with ESC characters before including it in this field. A 5-byte BCD field indicating the cost of the event. A 16-bit field that indicates the packages to which this event belongs. The most-significant bit corresponds to the first package while the least significant bit corresponds to the 16-th package. If the event belongs to the k-th package, then the k-th bit of this field shall be set to one. More than one bit can be set to one to show an event that belongs to multiple packages. A 64-bit field for the DES key (or a 168-bit field for the TDES key) necessary for de-scrambling the video and audio signals for the event under consideration. A 40-bit field indicating that the user needs to obtain a new private key or verification key by calling the CA server. If flag is set to 1, the key needs to be replaced until the indicated deadline. An 8-bit field for identifying the total length (in bytes) of the AIM descriptor list that follows.

In one embodiment of the present invention, entitlement control messages (ECMs) may be used instead of AIMs. The format of the ECM is privately defined according to MPEG-2 and ATSC specifications. A particular format that may be used comprises an 8-bit table identification field, 3 indicator bits, a 12-bit section length field, an 8-bit protocol version field, a 5 bit version number field, 2 section number fields, a public key field, a transport stream identification field, major and minor channel number fields, 2 event identification fields, a stream PID and descriptors length fields, a cryption check field, a stuffing bytes field, and a 32-bit CRC field.

The security of the system is based on standard and widely accepted public key and symmetric key algorithms. The algorithms chosen are RSA for public key encryption and TDES and/or DES for symmetric key scrambling.

In a first preferred embodiment of the present invention, there is one global RSA public/private key pair, K_{pub}/Kₚᵣᵢ, for performing encryption for the entire system. The public key (K_{pub}) is shared by all the broadcasters and the corresponding private key (Kₚᵣᵢ) is placed in the tamper-proof NRSS-A based smart cards, distributed by the CA providers to the consumers. This public key is used to protect the AIMs generated at the head-end.

In second preferred embodiment of the present invention, a plurality of public/private key pairs are used for performing encryption (K_{pub1}/Kₚᵣᵢ₁, K_{pub2}/Kₚᵣᵢ₂, K_{pub3}/Kₚᵣᵢ₃, etc.), each key pair corresponding to a particular broadcaster or geographic region.

For example, take an individual who lives in Princeton, N.J. Such an individual has the ability to receive broadcasts from various broadcast sources (i.e., they can receive broadcasts from Philadelphia area broadcasters, Trenton area broadcasters, and New York City area broadcasters, just to name a few). By using a conditional access system with multiple key pairs, where each key pair corresponds to different broadcaster (e.g., K_{pub1}/Kₚᵣᵢ₁corresponds to a Philadelphia broadcaster, K_{pub2}/Kₚᵣᵢ₂ corresponds to a Trenton broadcaster, and K_{pub3}/Kₚᵣᵢ₃ corresponds to a New York City broadcaster), the individual in Princeton can receive and descramble transmissions sent by each broadcaster. In particular, each broadcaster may use their own public key (K_{pub1-3}) to encrypt their ECMs or AIMs (carrying the descrambling keys). Then, each transmission from the broadcaster may be descrambled by using the corresponding private keys (Kₚᵣᵢ₁₋₃) to recover the descrambling keys. The private keys (Kₚᵣᵢ₁₋₃) may be disposed in a smart card or smart cards of a set-top box or digital television of the individual user.

In this second preferred embodiment, each broadcaster may use a separate public key to encrypt their descrambling keys (e.g., Philadelphia broadcaster could use a first public key (K_{pub1}), Trenton broadcaster could use a second public key (K_{pub2}), etc.). If the Princeton area user has a set-top box or digital television with the corresponding private keys (Kₚᵣᵢ₁, Kₚᵣᵢ₂) for each public key (K_{pub1}, K_{pub2}), they can descramble the transmissions from all local broadcasters.

Within an ECM or AIM, a byte of data (which will be referred to as the ‘ECM Key ID’) is used to indicate which of the ECM keys is used to encrypt the particular ECM. The conditional access device (e.g., set top box) includes a smart card which stores the ECMs and the ECM Key IDs. For example, if the smart card were capable of holding five (5) ECMs, and the ECMs were encrypted using TDES, an exemplary memory map of the card may appear as shown below in Table I. In the example given below in Table 1, the exemplary smart card includes three (3) active keys with identification values‘55’, ‘AA’ and ‘01.’

TABLE I

| Memory Location | Contents | Value |
|---|---|---|
| 100 | ECM_Key_ID1 | 0 × 55 |
| 101 | ECM_Key_ID2 | 0 × AA |
| 102 | ECM_Key_ID3 | 0 × 01 |
| 103 | ECM_Key_ID4 | 0 × 00 |
| 104 | ECM_Key_ID5 | 0 × 00 |
| 105-129 | ECM_Key1 | ‘key 1’ (e.g., 0 × 123456) |
| 130-153 | ECM_Key2 | ‘key 2’ (e.g., 0 × 234567) |
| 154-177 | ECM_Key3 | ‘key 3’ (e.g., 0 × 345678) |
| 178-201 | ECM_Key4 | 0 × 000000 |
| 202-225 | ECM_Key5 | 0 × 000000 |

When an ECM is received by the conditional access module (e.g., set top box), software in the module takes the ECM Key ID information from the ECM, and looks for an entry in the ECM Key ID field of the smart card. For example, if an ECM with the value 0×01 in its ECM Key ID field is received, ECM Key ID 3 is specified, and thus the software will use ‘key 3’ to decrypt the ECM. Based on the entitlements carried in the ECM, the smart card makes a decision about whether to authorize the user for a particular program. If the user is authorized, the conditional access module (e.g., set top box) loads the audio-visual stream and descrambles the stream using the decrypted descrambling key.

In a third preferred embodiment of the present invention, different geographic areas may be assigned different key pairs. Alternatively from the ‘per broadcaster’ example given above, the different key pairs can be assigned to different geographic regions in which many broadcasters operate, so that more than one broadcaster in the region may utilize the same key pair. Using the above example, the area in a 100 mile radius around Philadelphia may be assigned a first key pair (K_{pub1}/Kₚᵣᵢ₁), the area in a 100 mile radius around Trenton may be assigned a second key pair (K_{pub2}/Kₚᵣᵢ₂), and the area in a 100 mile radius around New York City may be assigned a third key pair (K_{pub3}/Kₚᵣᵢ₃). In this way, two broadcasters in the vicinity of Philadelphia may use the same key pair. Since Princeton is located in a geographic region which is covered by all the three different key pairs described above, a conditional access user in Princeton would have all three corresponding private keys (Kₚᵣᵢ₁₋₃) in their set-top box or digital television for descrambling the different broadcast signals.

Using the above geographic division example, a user in Princeton would likely have in their smart card (of their set-top box or digital television) the private keys for the Trenton, New York, Philadelphia and any other surrounding geographic regions. However, it will be noted that a user in a specific geographic area will not necessarily require the private keys for a geographic area from which they cannot receive transmissions (i.e., a user in California might not necessarily need the private key for Philadelphia area transmissions).

Although the above ‘per broadcaster’ and ‘per geographic area’ examples discuss using multiple public/private key pairs to encrypt and decrypt the ECMs, it will be noted by those skilled in the art that multiple symmetric keys may also be used for encryption and decryption. Those of ordinary skill in the art will realize that it is also possible to utilize access information from which the descrambling keys may be derived by some predefined process (e.g., hashing). For example, if raw data were hashed to obtain a descrambling key or keys, such raw data could be sent in the clear along with the scrambled content from the transmitter to the conditional access receiver. Then, at the receiver, the raw data would be hashed to derive the descrambling key or keys.

The E-cash Certificates carry the amount of money to be added to the card. The Package Certificates include the price of the package offered to the customer. Since both of the certificates carry sensitive data, there needs to be a signature mechanism to ensure the integrity of these messages. Therefore, all certificates are sent via a channel with a feedback path, for example, a back channel using a MODEM.

Although the Package Certificates are normally sent from the CA server, there may be different sources (e.g., ATMs or other special terminals) for downloading E-cash to the card. If each source signs with a unique private key, the DTV needs to keep multiple public keys. The present CA system employs an ID-based authentication scheme to allow signature verification using only one public key.

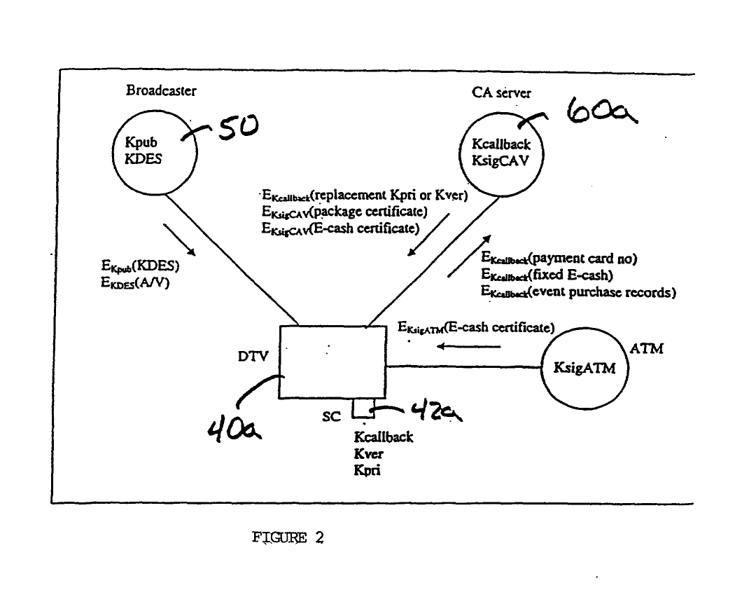

As mentioned earlier, to participate in the scrambling, encryption and signature protocols, the broadcasters, CA servers and the smart cards will need to store certain keys. The storage and use of all types of keys are summarized in FIG. 2.

Kpub is kept at the broadcaster site, and is used to encrypt the DES keys that are locally generated to scramble the A/V streams. The card has the corresponding Kpri for recovering the DES keys.

Ksig is used to sign package and E-cash certificates. The signed certificates are verified with Kver stored on the card. In the ID-based scheme described in Section 8.2, Ksig is unique for each certificate provider (CA vendors, ATMs, etc.) but Kver is common to all certificate providers.

Kcallback is shared between the card and the CA server, and is used to encrypt sensitive information exchanged. The information sent from the card to the CA server is payment card no, fixed E-cash and event purchase records. When needed, Kpri and Kver are replaced by the CA server. Kcallback may be unique for each card. Its replacement is only possible by sending a new card to the user.

What is claimed is:

1. A method for managing access to a restricted transmitted event, said method comprising:
(a) receiving at least one first transmitted event from a first service provider, said transmitted event being scrambled;
(b) receiving at least one second transmitted event from a second service provider, said transmitted event being scrambled;
(c) receiving encrypted access information associated with said transmitted events, said access information including first and second descrambling keys, said first descrambling key corresponding to said first service provider and said second descrambling key corresponding to said second service provider;
(d) decrypting said access information; and,
(e) descrambling said transmitted events.

2. The method of claim 1 wherein the steps of decrypting and descrambling are performed in a smart card, said encrypted access information being encrypted using respective first and second public keys and being decrypted using a corresponding respective first and second private keys stored in said smart card.

3. The method of claim 1 wherein the steps of decrypting and descrambling are performed in a smart card, said encrypted access information being encrypted using respective first and second symmetric keys and being decrypted using a corresponding respective first and second symmetric keys stored in said smart card.

4. The method of claim 1 wherein said smart card comprises a card body with a plurality of terminals arranged on a surface of said card body in accordance with one of ISO 7816 and PCMCIA card standards.

5. The method of claim 1, wherein the first service provider's broadcast area is adjacent to the second service provider's broadcast area.

6. The method of claim 1, wherein the first service provider's broadcast area is overlapping with respect to the second service provider's broadcast area.

7. A method for allowing a digital video apparatus to manage access to a restricted transmitted event comprises the steps of:
(a) receiving, from a first service provider, access information encrypted using a first public key, said access information including a first encrypted event key;
(b) receiving, from a second service provider, access information encrypted using a second public key, said access information including a second encrypted event key;
(c) passing said first and second event keys to a smart card coupled to said digital video apparatus;
(d) receiving a first transmitted event from said first service provider, said first transmitted event being scrambled using said first event key;
(e) receiving a second transmitted event from said second service provider, said second transmitted event being scrambled using said second event key; and,
(f) decrypting, in said smart card, one of said first and second encrypted event keys.

8. The method of claim 7, comprising the further steps of:
(g) passing at least one of said first and second transmitted events to said smart card;
(h) descrambling, in said smart card, one of said first and second transmitted events using said one of said first and second event keys; and
(i) passing said descrambled transmitted event to said digital video apparatus.

9. A conditional access system comprising:
at least two program service providers; and,
at least one digital device for receiving scrambled transmitted signals from the at least two service providers, said digital device including at least one smart card for descrambling said scrambled transmitted signals, wherein said at least one smart card includes at least two decryption keys for decrypting at least two respective descrambling keys, said descrambling keys being used to descramble the transmitted signals received from the at least two service providers.

10. The conditional access system of claim 9, wherein the at least two decryption keys comprise at least two private keys.

11. The conditional access system of claim 9, wherein the at least two decryption keys comprise at least two symmetric keys.

12. The conditional access system of claim 9, wherein a first of the at least two service providers scrambles signals using a first scrambling key encrypted by a first public key, and a second of the at least two service providers scrambles signals using a second scrambling key encrypted by a second public key, such that a first of the at least two private keys is used to recover the first scrambling key and descramble the signals of the first service provider, and a second of the at least two private keys is used to recover the second scrambling key and descramble the signals of the second service provider.

13. The conditional access system of claim 9, wherein a first of said at least two service providers is disposed in a first geographic region, and a second of said at least two service providers is disposed in a second geographic region adjacent to, but different from, said first geographic region.

14. The conditional access system of claim 9, wherein a first of said at least two service providers is disposed in a first broadcast region, and a second of said at least two service providers is disposed in a second broadcast region adjacent to, but different from, said first broadcast region.

15. A method for managing access to a plurality of restricted transmitted events, said method comprising:
(a) receiving a plurality of transmitted events from a plurality of different service providers, said transmitted events being scrambled;
(b) receiving encrypted access information from the plurality of different service providers associated with said plurality of transmitted events, said access information comprising a plurality of descrambling keys, each of said plurality of descrambling keys corresponding to each of said plurality of service providers;
(c) decrypting said access information; and,
(d) descrambling said plurality of transmitted events.

16. A method for providing conditional access, comprising the steps of:
(a) assigning a first key pair to a first geographic region;
(b) assigning a second key pair to a second geographic region different from said first geographic region;
(c) permitting a broadcaster within the first geographic region to use a public key of said first scrambling key pair to encrypt at least one descrambling key;
(d) permitting a broadcaster within the second geographic region to use a public key of said second scrambling key pair to encrypt at least one descrambling key;
(e) providing a private key of said first scrambling key pair and a private key of said second scrambling key pair in a digital device; and
(f) permitting a user conditional access to said scrambled transmitted signals from said first and second geographic regions by utilizing the private keys provided in the digital device.

17. A method for managing access to a restricted transmitted event, said method comprising:
(a) receiving at least one first transmitted event from a first service provider, said transmitted event being scrambled;
(b) receiving at least one second transmitted event from a second service provider, said transmitted event being scrambled;
(c) receiving access information associated with said transmitted events;
(d) deriving first and second descrambling keys from said access information, said first descrambling key corresponding to said first service provider and said second descrambling key corresponding to said second service provider; and,
(e) descrambling said transmitted events using said first and second descrambling keys.
